(19) United States
(12) Patent Application Publication
(10) Pub. No.: US 2024/0428978 A1
(43) Pub. Date: Dec. 26, 2024

(54) MAGNETIC COMPONENT

(71) Applicant: CYNTEC CO., LTD., Hsinchu (TW)

(72) Inventors: Chi-Shiuan Shie, Hsinchu (TW); Chia-Hsing Chou, Hsinchu (TW)

(73) Assignee: CYNTEC CO., LTD., Hsinchu (TW)

(21) Appl. No.: 18/748,081

(22) Filed: Jun. 19, 2024

Related U.S. Application Data
(60) Provisional application No. 63/523,110, filed on Jun. 25, 2023.

(51) Int. Cl. H01F 27/26; H01F 27/30

(52) U.S. Cl. CPC H01F 27/26; H01F 27/306

(57) ABSTRACT

A magnetic component includes a core, a first winding, a second winding and at least one magnetic filler. The core includes an inner leg. The first winding is disposed in the core and wound around the inner leg. The second winding is disposed in the core and surrounds the first winding. At least one filling region and at least one non-filling region are formed between the first winding and the second winding. The at least one magnetic filler is filled in at least a part of the at least one filling region.

### CROSS REFERENCE TO RELATED APPLICATIONS

This application claims the benefit of U.S. Provisional Application No. 63/523,110, filed on Jun. 25, 2023. The content of the application is incorporated herein by reference.

### BACKGROUND OF THE INVENTION

### 1. Field of the Invention

The invention relates to a magnetic component and, more particularly, to a magnetic component capable of effectively increasing leakage inductance.

### 2. Description of the Related Art

A circuit architecture equipped with multi-phase trans-inductors is used to achieve fast dynamic response. Since the leakage inductance of the multi-phase trans-inductors is insufficient, the multi-phase trans-inductors need to be connected with an additional inductor in series to increase the leakage inductance. However, the additional inductor will increase manufacturing cost and occupy additional space on a mainboard.

### SUMMARY OF THE INVENTION

The invention provides a magnetic component capable of effectively increasing leakage inductance, so as to solve the aforesaid problems.

According to an embodiment of the invention, a magnetic component includes a core, a first winding, a second winding and at least one magnetic filler. The core includes an inner leg. The first winding is disposed in the core and wound around the inner leg. The second winding is disposed in the core and surrounds the first winding. At least one filling region and at least one non-filling region are formed between the first winding and the second winding. The at least one magnetic filler is filled in at least a part of the at least one filling region.

In an embodiment, a gap of the at least one filling region is larger than a gap of the at least one non-filling region.

In an embodiment, the gap of the at least one filling region is larger than or equal to three times the gap of the at least one non-filling region.

In an embodiment, a gap of the at least one filling region is larger than or equal to 0.5 mm.

In an embodiment, the core includes a first core member and a second core member, the first winding and the second winding are located between the first core member and the second core member, and the at least one magnetic filler is not in contact with the first core member and the second core member simultaneously.

In an embodiment, the at least one magnetic filler is made of a magnetic glue.

In an embodiment, the at least one magnetic filler is a magnetic block.

In an embodiment, the at least one magnetic filler is formed with the core integrally.

In an embodiment, the core includes a first core member and a second core member, the first winding and the second winding are located between the first core member and the second core member, the at least one magnetic filler includes a first protruding member and a second protruding member opposite to each other, the first protruding member protrudes from the first core member, and the second protruding member protrudes from the second core member.

In an embodiment, the core includes at least one air gap, and the magnetic component further includes at least one air gap filler filled in the at least one air gap.

In an embodiment, the at least one air gap filler is made of a magnetic material.

In an embodiment, the at least one air gap filler is made of a non-magnetic material.

In an embodiment, the first winding includes a first top portion and two first side portions, the first top portion is connected between the two first side portions, the second winding includes a second top portion and two second side portions, the second top portion is connected between the two second side portions, the first top portion corresponds to the second top portion, and the two first side portions correspond to the two second side portions.

In an embodiment, the at least one filling region is located between the first top portion and the second top portion, and the at least one non-filling region is located between the two first side portions and the two second side portions.

In an embodiment, the at least one filling region is located between the two first side portions and the two second side portions, and the at least one non-filling region is located between the first top portion and the second top portion.

In an embodiment, the first winding and the second winding define a boundary of the at least one filling region.

In an embodiment, the at least one magnetic filler is filled up to the boundary of the at least one filling region.

In an embodiment, the at least one magnetic filler is in contact with the first winding and the second winding.

As mentioned in the above, the invention fills the magnetic filler in the filling region between the first winding and the second winding, such that the leakage inductance of the magnetic component may be effectively increased without increasing the height of the magnetic component too much. Accordingly, the magnetic component may be used in a DC-to-DC converter to provide sufficient leakage inductance without the need of connecting an additional inductor in series. Thus, the manufacturing cost will be reduced and the space on a mainboard will not be occupied by the additional inductor.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a perspective view illustrating a magnetic component according to an embodiment of the invention.

FIG. 2 is an exploded view illustrating the magnetic component shown in FIG. 1.

FIG. 3 is a sectional view illustrating the magnetic component shown in FIG. 1.

FIG. 4 is another sectional view illustrating the magnetic component shown in FIG. 1.

FIG. 5 is a side view illustrating the core shown in FIG. 1.

FIG. 6 is a sectional view illustrating the magnetic component according to another embodiment of the invention.

FIG. 7 is a sectional view illustrating the magnetic component according to another embodiment of the invention.

FIG. 8 is a sectional view illustrating different types of the magnetic filler filled in the filling region.

### DETAILED DESCRIPTION

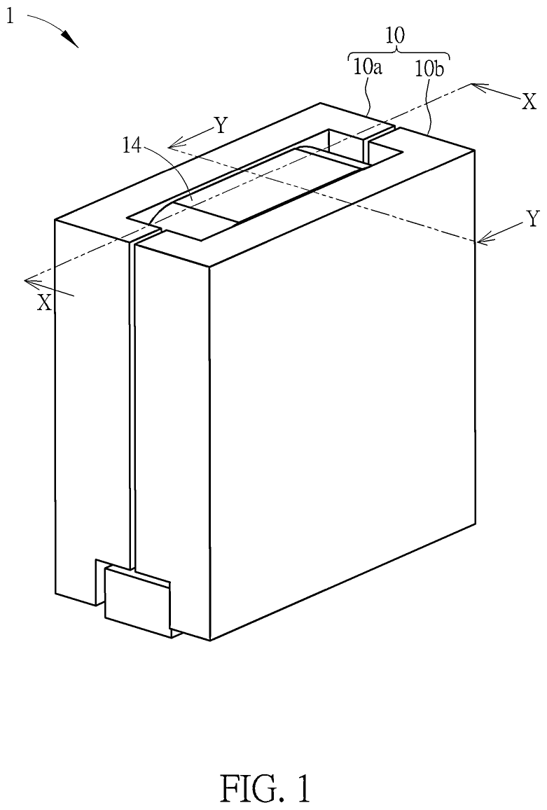

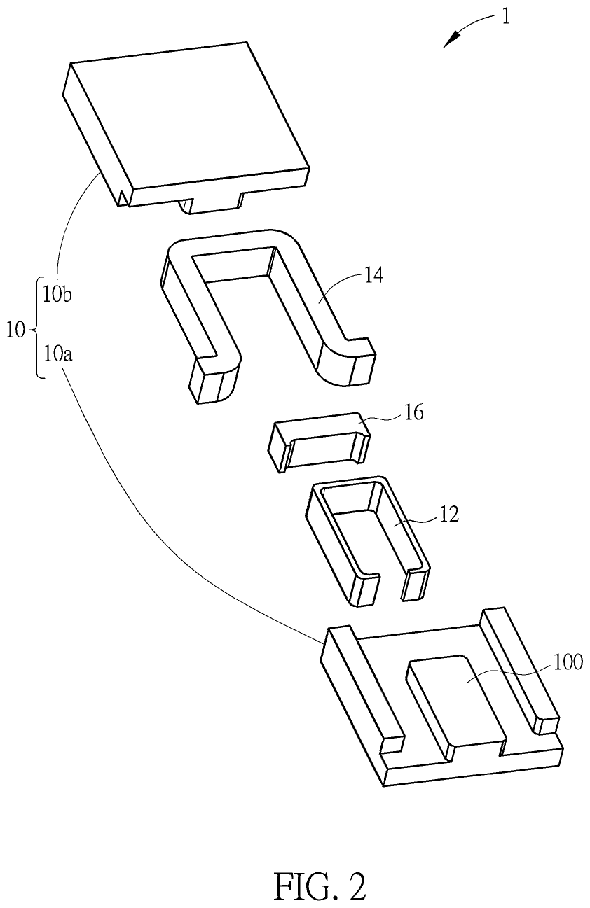

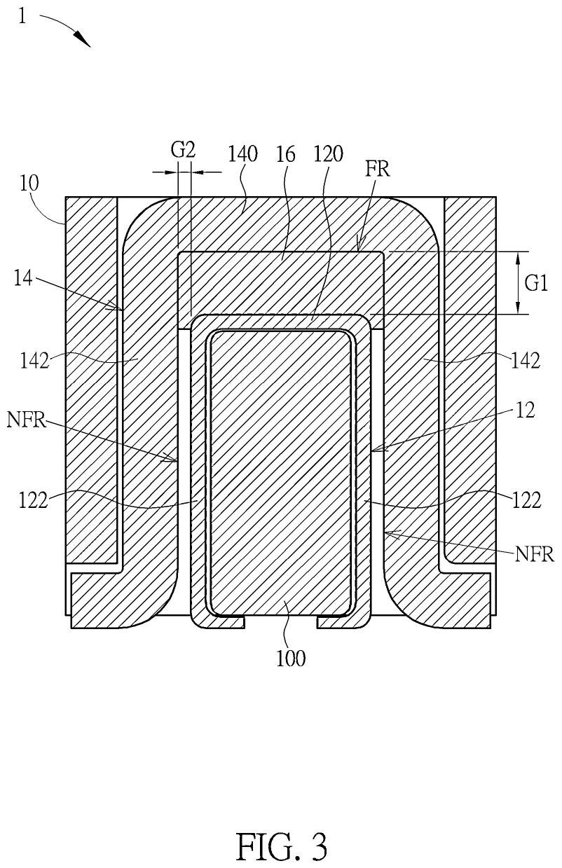

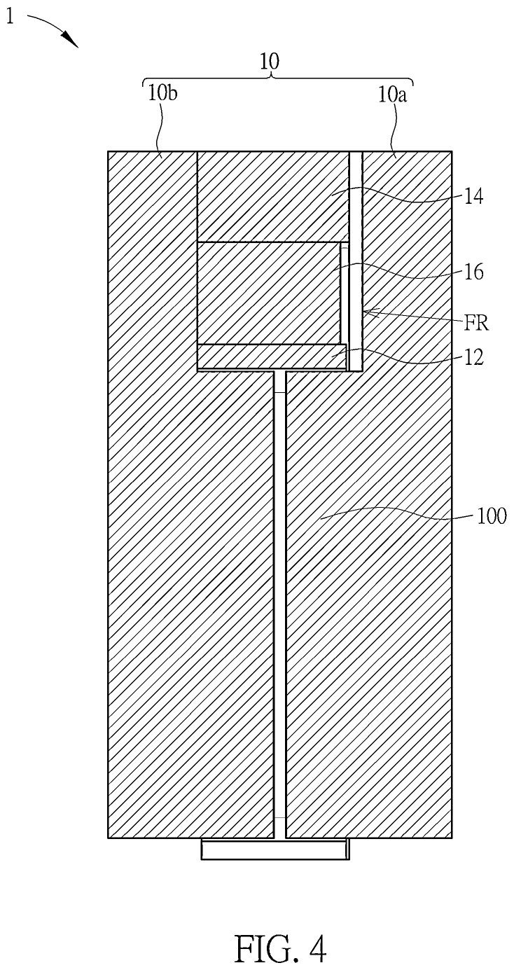

Referring to FIGS. 1 to 4, FIG. 1 is a perspective view illustrating a magnetic component 1 according to an embodiment of the invention, FIG. 2 is an exploded view illustrating the magnetic component 1 shown in FIG. 1, FIG. 3 is a sectional view illustrating the magnetic component 1 along line X-X shown in FIG. 1, and FIG. 4 is another sectional view illustrating the magnetic component 1 along line Y-Y shown in FIG. 1.

As shown in FIGS. 1 to 4, a magnetic component 1 of the invention includes a core 10, a first winding 12, a second winding 14 and at least one magnetic filler 16. The magnetic component 1 may be a trans-inductor, a coupling choke, or other magnetic components according to practical applications.

The core 10 includes an inner leg 100. The first winding 12 is disposed in the core 10 and wound around the inner leg 100. The second winding 14 is disposed in the core 10 and surrounds the first winding 12. In this embodiment, the core 10 may include a first core member 10a and a second core member 10b. The first core member 10a and the second core member 10b both may be E cores. The effective magnetic field strengths of two E cores will be similar, which may effectively improve component efficiency. Furthermore, the two E cores and the windings may be fixed to each other through a mechanical manner, which may increase the strength and reduce the chance of falling off. In another embodiment, one of the first core member 10a and the second core member 10b may be an E core, and the other one of the first core member 10a and the second core member 10b may be an I core. The types of the first core member 10a and the second core member 10b may be determined according to practical applications, so the invention is not limited to the embodiment shown in the figure. In an embodiment, the inner leg 100 may be integrally formed with the first core member 10a or the second core member 10b. In another embodiment, the inner leg 100 may be divided into two segments integrally formed with the first core member 10a and the second core member 10b, respectively. When the core 10 consists of the first core member 10a and the second core member 10b, the first winding 12 and the second winding 14 are located between the first core member 10a and the second core member 10b.

As shown in FIG. 3, the second winding 14 is apart from the first winding 12, such that at least one filling region FR and at least one non-filling region NFR are formed between the first winding 12 and the second winding 14. Thus, the first winding 12 and the second winding 14 define a boundary of the at least one filling region FR. In this embodiment, one filling region FR and two non-filling regions NFR are defined between the first winding 12 and the second winding 14. In this embodiment, the first winding 12 may include a first top portion 120 and two first side portions 122. The first top portion 120 is connected between the two first side portions 122. Furthermore, the second winding 14 may include a second top portion 140 and two second side portions 142. The second top portion 140 is connected between the two second side portions 142. When the first winding 12 and the second winding 14 are disposed in the core 10, the first top portion 120 corresponds to the second top portion 140, and the two first side portions 122 correspond to the two second side portions 142. Thus, the filling region FR is located between the first top portion 120 and the second top portion 140, and the two non-filling regions NFR are located between the two first side portions 122 and the two second side portions 142.

As shown in FIG. 3, one magnetic filler 16 is filled in at least a part of the filling region FR. In this embodiment, the magnetic filler 16 may be filled up to the boundary of the filling region FR, such that the magnetic filler 16 may be in contact with the first winding 12 and the second winding 14. The magnetic filler 16 may be made of a magnetic glue, but the invention is not so limited. The advantage of magnetic glue is that the production line may adjust the amount of magnetic glue to adjust the required characteristics. In another embodiment, the magnetic filler 16 may be a magnetic block separately filled in the filling region FR. The advantage of magnetic block is that the process is simple since the magnetic block just needs to be put in a desired position.

Furthermore, a gap G1 of the filling region FR may be larger than a gap G2 of the non-filling region NFR. Since the second winding 14 is apart from the first winding 12 with the gap G1 of the filling region FR and the gap G2 of the non-filling region NFR, and the magnetic filler 16 is filled in the filling region FR, the leakage inductance of the magnetic component 1 may be effectively increased without increasing the height of the magnetic component 1 too much. In an embodiment, the gap G1 of the filling region FR may be larger than or equal to three times the gap G2 of the non-filling region NFR, i.e., G1≥3*G2, so as to further improve the leakage inductance of the magnetic component 1. In another embodiment, the gap G1 of the filling region FR may be larger than or equal to 0.5 mm, so as to further improve the leakage inductance of the magnetic component 1.

As shown in FIG. 4, the magnetic filler 16 may be not in contact with the first core member 10a and the second core member 10b simultaneously, so as to avoid affecting the magnetic permeability of between the first winding 12 and the second winding 14 and to avoid affecting the leakage inductance path. In this embodiment, the magnetic filler 16 may be in contact with the second core member 10b and not in contact with the first core member 10a, but the invention is not so limited. In another embodiment, the magnetic filler 16 may be in contact with the first core member 10a and not in contact with the second core member 10b, and it depends on practical applications.

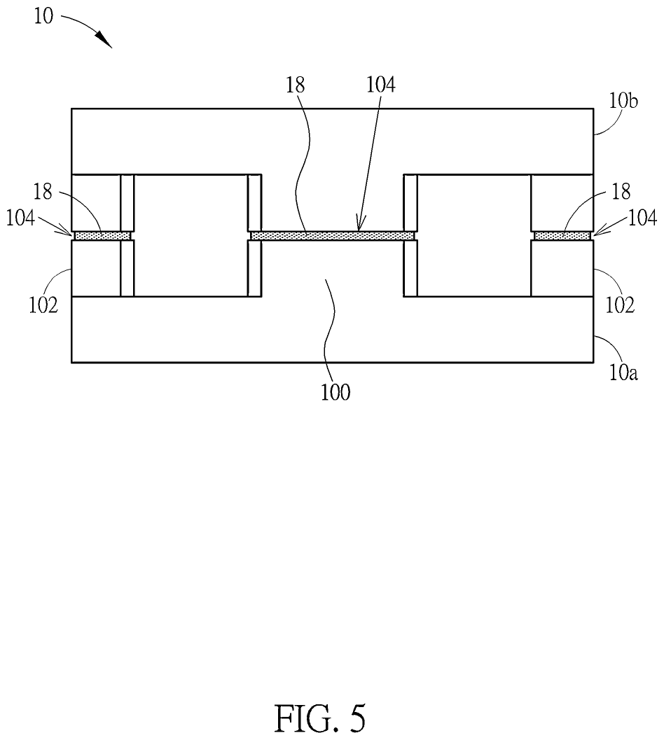

Referring to FIG. 5, FIG. 5 is a side view illustrating the core 10 shown in FIG. 1.

As shown in FIG. 5, the core 10 may include at least one outer leg 102 and at least one air gap 104. In this embodiment, the core 10 may include two outer legs 102 and three air gaps 104. The three air gaps 104 are respectively formed at the inner leg 100 and the two outer legs 102. It should be noted that the number and position of outer legs 102 and air gaps 104 may be determined according to practical applications, so the invention is not limited to the embodiment shown in the figure. Furthermore, the magnetic component 1 may further include at least one air gap filler 18 filled in the at least one air gap 104. The at least one air gap filler 18 may be made of a magnetic material or a non-magnetic material. For example, the air gap filler 18 may be composed of non-magnetic material, such as air, insulating glue, insulating paper, etc., or alternatively. The air gap filler 18 may include, but is not limited to, adhesive material with magnetic powder, separately added magnetic block, or protruded structure integrated with the core 10. The air gap 104 with the air gap filler 18 may make the magnetic field intensity more balanced and achieve better saturation and efficiency.

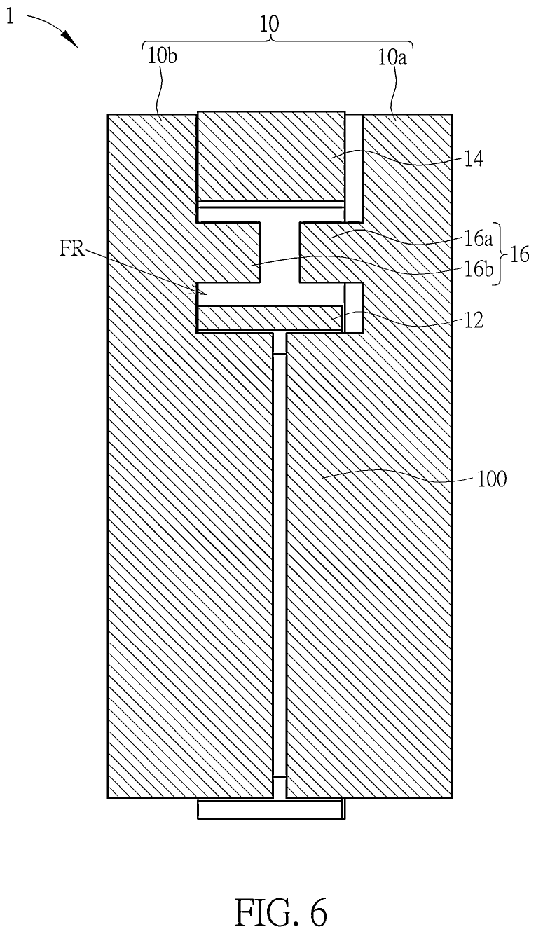

Referring to FIG. 6, FIG. 6 is a sectional view illustrating the magnetic component 1 according to another embodiment of the invention.

As shown in FIG. 6, the at least one magnetic filler 16 may be formed with the core 10 integrally. For example, the at least one magnetic filler 16 may include a first protruding member 16a and a second protruding member 16b opposite to each other. The first protruding member 16a protrudes from the first core member 10a toward the second core member 10b, and the second protruding member 16b protrudes from the second core member 10b toward the first core member 10a. The first protruding member 16a may be not in contact with the second protruding member 16b, such that there is a gap between the first protruding member 16a and the second protruding member 16b. The advantage of protruding member formed with the core integrally is that the assembly is simple and it only needs to control the air gap of main inductance.

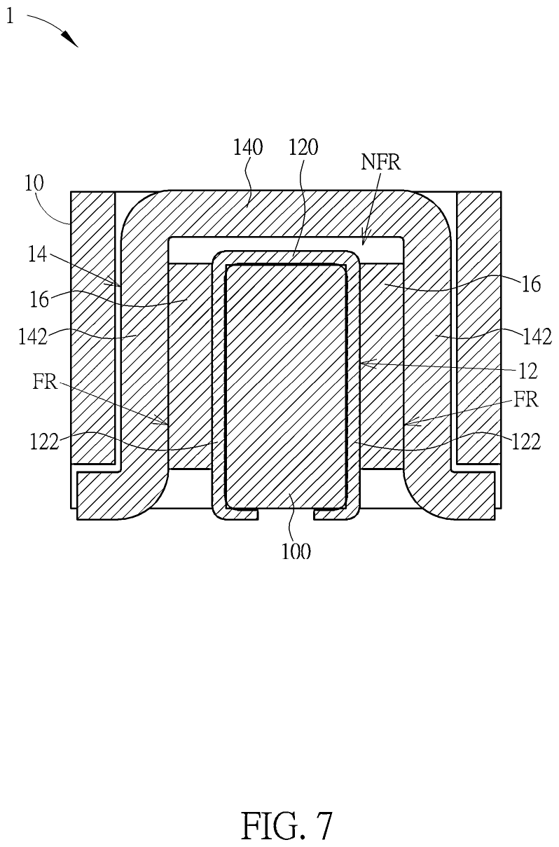

Referring to FIG. 7, FIG. 7 is a sectional view illustrating the magnetic component 1 according to another embodiment of the invention.

As shown in FIG. 7, the at least one filling region FR may be located between the two first side portions 122 of the first winding 12 and the two second side portions 142 of the second winding 14, and the at least one non-filling region NFR may be located between the first top portion 120 of the first winding 12 and the second top portion 140 of the second winding 14. In this embodiment, two filling regions FR are located between the two first side portions 122 and the two second side portions 142, and one non-filling region NER is located between the first top portion 120 and the second top portion 140. Furthermore, two magnetic fillers 16 are filled in at least a part of the two filling regions FR. In this embodiment, the magnetic fillers 16 may be filled up to the boundary of the filling regions FR, such that the magnetic fillers 16 may be in contact with the first winding 12 and the second winding 14.

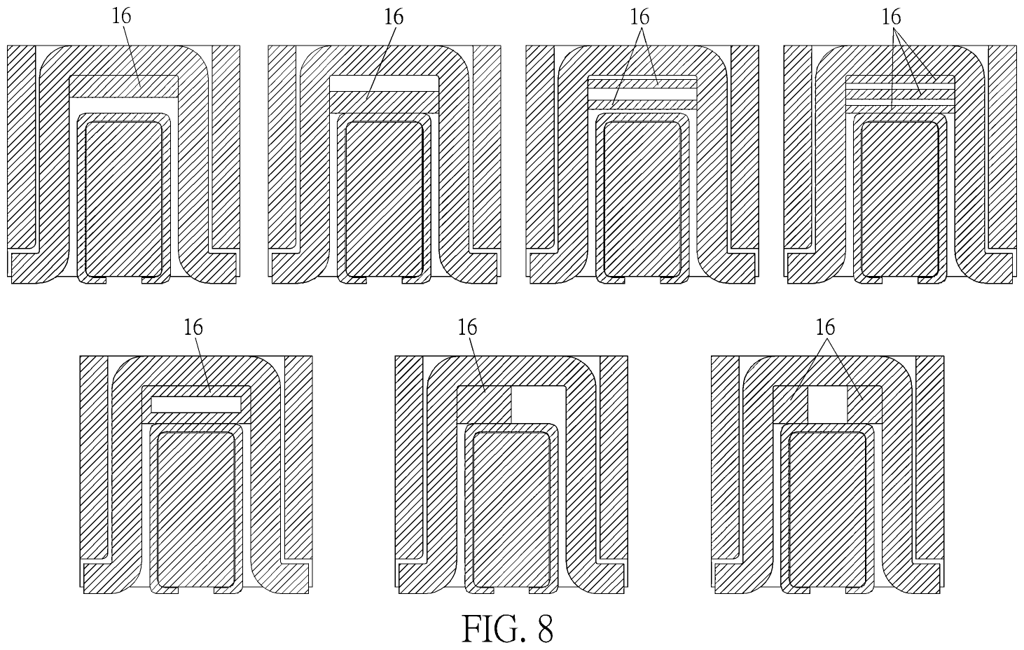

Referring to FIG. 8, FIG. 8 is a sectional view illustrating different types of the magnetic filler 16 filled in the filling region FR.

As shown in FIG. 8, the magnetic filler 16 filled in the filling region FR to increase leakage inductance is not limited to a single shape, location, or quantity. The proportion of the magnetic filler 16 occupying the filling region FR to form a leakage inductance path may be the magnetic filler 16 connecting the air and the core in series, or the magnetic filler 16 connecting the air in parallel and then connecting the core in series. The magnetic filler 16 may be arranged in different shapes on the leakage inductance path, and the magnetic permeability of the magnetic filler 16 may be smaller than that of the core.

As mentioned in the above, the invention fills the magnetic filler in the filling region between the first winding and the second winding, such that the leakage inductance of the magnetic component may be effectively increased without increasing the height of the magnetic component too much. Accordingly, the magnetic component may be used in a DC-to-DC converter to provide sufficient leakage inductance without the need of connecting an additional inductor in series. Thus, the manufacturing cost will be reduced and the space on a mainboard will not be occupied by the additional inductor.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A magnetic component comprising:
a core comprising an inner leg;
a first winding disposed in the core and wound around the inner leg;
a second winding disposed in the core and surrounding the first winding, at least one filling region and at least one non-filling region being formed between the first winding and the second winding; and
at least one magnetic filler filled in at least a part of the at least one filling region.

2. The magnetic component of claim 1, wherein a gap of the at least one filling region is larger than a gap of the at least one non-filling region.

3. The magnetic component of claim 2, wherein the gap of the at least one filling region is larger than or equal to three times the gap of the at least one non-filling region.

4. The magnetic component of claim 1, wherein a gap of the at least one filling region is larger than or equal to 0.5 mm.

5. The magnetic component of claim 1, wherein the core comprises a first core member and a second core member, the first winding and the second winding are located between the first core member and the second core member, and the at least one magnetic filler is not in contact with the first core member and the second core member simultaneously.

6. The magnetic component of claim 1, wherein the at least one magnetic filler is made of a magnetic glue.

7. The magnetic component of claim 1, wherein the at least one magnetic filler is a magnetic block.

8. The magnetic component of claim 1, wherein the at least one magnetic filler is formed with the core integrally.

9. The magnetic component of claim 1, wherein the core comprises a first core member and a second core member, the first winding and the second winding are located between the first core member and the second core member, the at least one magnetic filler comprises a first protruding member and a second protruding member opposite to each other, the first protruding member protrudes from the first core member, and the second protruding member protrudes from the second core member.

10. The magnetic component of claim 1, wherein the core comprises at least one air gap, and the magnetic component further comprises at least one air gap filler filled in the at least one air gap.

11. The magnetic component of claim 10, wherein the at least one air gap filler is made of a magnetic material.

12. The magnetic component of claim 10, wherein the at least one air gap filler is made of a non-magnetic material.

13. The magnetic component of claim 1, wherein the first winding comprises a first top portion and two first side portions, the first top portion is connected between the two first side portions, the second winding comprises a second top portion and two second side portions, the second top portion is connected between the two second side portions, the first top portion corresponds to the second top portion, and the two first side portions correspond to the two second side portions.

14. The magnetic component of claim 13, wherein the at least one filling region is located between the first top portion and the second top portion, and the at least one non-filling region is located between the two first side portions and the two second side portions.

15. The magnetic component of claim 13, wherein the at least one filling region is located between the two first side portions and the two second side portions, and the at least one non-filling region is located between the first top portion and the second top portion.

16. The magnetic component of claim 1, wherein the first winding and the second winding define a boundary of the at least one filling region.

17. The magnetic component of claim 16, wherein the at least one magnetic filler is filled up to the boundary of the at least one filling region.

18. The magnetic component of claim 17, wherein the at least one magnetic filler is in contact with the first winding and the second winding.
